(19) United States
(12) Patent Application Publication
(10) Pub. No.: US 2007/0081129 A1
(43) Pub. Date: Apr. 12, 2007

(54) Modular beam-recombining system and beam-recombining method threof

(76) Inventor: Chi-Wen Lin, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/246,080

(22) Filed: Oct. 11, 2005

(51) Int. Cl. G03B 21/14

(52) U.S. Cl. 353/20

(57) ABSTRACT

A modular beam-recombining system includes a beam splitting/recombining module, a splitting-beam reflecting module, a polarizing beam splitter module, and an image displaying module. The beam splitting/recombining module is used to directly receive a beam from a light-emitting module, and splitting and recombining the beam. The splitting-beam reflecting module is connected with the beam splitting/recombining module for reflecting the beam from the beam splitting/recombining module. The polarizing beam splitter module is arranged correspondingly above the splitting-beam reflecting module for receiving the beam from the splitting-beam reflecting module, and the image displaying module is arranged correspondingly above the polarizing beam splitter module for receiving and reflecting the beam from the polarizing beam splitter module to form an image beam. Whereby, the modular beam-recombining system includes the advantages of having the same RGB optical path, high contrast, a high optical level, small volume and ease of manufacture.

### BACKGROUND OF THE INVENTION

1. Field of the Invention

The present invention relates to a modular beam-recombining system and a beam-recombining method thereof, and particularly relates a modular beam-recombining system having a beam splitting/recombining module, a splitting-beam reflecting module, a polarizing beam splitter module and an image displaying module all integrated together.

2. Description of the Related Art

Referring to FIG. 1, U.S. Pat. No. 6,345,895 shows a beam-recombining system. The beam-recombining system includes a dichroic module 20a, a beam-recombining module 30a and a plurality of image displaying modules 40a. The dichroic module 20a has a plurality of reflecting mirrors 21a, a cross-type dichroic mirror 22a and a single-type dichroic mirror 23a.

Firstly, a beam is produced via a light-emitting module 10a, and the beam is reflected to the cross-type dichroic mirror 22a via one of the reflecting mirrors 21a for separating the beam into a B (blue) beam and a RG (read and green) beam. The B beam is reflected to the beam-recombining module 30a via another reflecting mirror 21a, and the RG beam is reflected to the single-type dichroic mirror 23a via the other reflecting mirror 21a for separating the RG beam into an R beam and a G beam and respectively transmitting the R beam and the G beam to the beam-recombining module 30a. Hence, the R, G and B beam can be transmitted into the beam-recombining module 30a along the same optical path. Afterward, the R, G and B beam are transmitted into the corresponding image displaying modules 40a for changing the R, G and B beam into image beams. Finally, the image beams are recombined and transmitted to a projection lens module 50a via the beam-recombining module 30a. Finally, the image beams are projected outside via the projection lens module 50a.

However, the beam-recombining system of the prior art has some defects, as are detailed below:

1. In order to produce the abovementioned optical path, the cross-type dichroic mirror 22a is an essential component in the beam-recombining system. However, the cross-type dichroic mirror 22a is composed of two single-type dichroic mirrors. Hence, cross traces and gaps are produced between two single-type dichroic mirrors, and beams with dark stripes are easily projected into the image displaying modules 40a due to the cross traces and the gaps.

2. When the beam is reflected, refracted, transmitted, scattered and diffracted continuously between the abovementioned optical components, the light corpuscle of the beam is also reduced continuously.

3. The beam-recombining system of the prior art is composed of the dichroic module 20a, the beam-recombining module 30a and the image displaying modules 40a. However, the assembly of the modules 20a, 30a and 40a occupies most of the volume of the beam-recombining system.

### SUMMARY OF THE INVENTION

The present invention provides a modular beam-recombining system and a beam-recombining method thereof. The modular beam-recombining system includes a beam splitting/recombining module, a splitting-beam reflecting module, polarizing beam splitter module and an image displaying module all integrated together for providing the following advantages:

1. Same RGB optical path;

2. High contrast;

3. High optical level (due to the fact that the splitting-beam reflecting module has an optical grind surface);

4. Small volume; and

5. Ease of manufacture.

A first aspect of the invention is a modular beam-recombining system including a reflecting module, a beam splitting/recombining module, a splitting-beam reflecting module, a polarizing beam splitter module, and an image displaying module. The reflecting module is used to reflect a beam from a light-emitting module. One side of the beam splitting/recombining module connects with the reflecting module for splitting and recombining the beam. The splitting-beam reflecting module is connected with the other side of the beam splitting/recombining module for reflecting the beam from the beam splitting/recombining module. The polarizing beam splitter module is arranged correspondingly above the splitting-beam reflecting module for receiving the beam from the splitting-beam reflecting module, and the image displaying module is arranged correspondingly above the polarizing beam splitter module, for receiving and reflecting the beam projected from the polarizing beam splitter module to form an image beam.

A second aspect of the invention is a modular beam-recombining system including a beam splitting/recombining module, a splitting-beam reflecting module, a polarizing beam splitter module, and an image displaying module. The beam splitting/recombining module is used to directly receive a beam from a light-emitting module, split and recombine the beam. The splitting-beam reflecting module is connected with the beam splitting/recombining module for reflecting the beam from the beam splitting/recombining module. The polarizing beam splitter module is correspondingly arranged above the splitting-beam reflecting module for receiving the beam from the splitting-beam reflecting module, and the image displaying module is arranged correspondingly above the polarizing beam splitter module for receiving and reflecting the beam from the polarizing beam splitter module to form an image beam.

A third aspect of the invention is a beam-recombining method of a modular beam-recombining system including: transmitting a beam from a light-emitting module to a beam splitting/recombining module; splitting the beam to form splitting beams via the beam splitting/recombining module; reflecting the splitting beams from the beam splitting/recombining module via a splitting-beam reflecting module connected with the beam splitting/recombining module; receiving the splitting beams from the splitting-beam reflecting module via a polarizing beam splitter module arranged correspondingly above the splitting-beam reflecting module; reflecting the splitting beams from the polarizing beam splitter module to form image beams via an image displaying module arranged correspondingly above the polarizing beam splitter module; reflecting the image beams from the image displaying module via the polarizing beam splitter module; and recombining the image beams from the polarizing beam splitter module via the beam splitting/recombining module.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a schematic view of a beam-recombining system in accordance with the prior art;

FIG. 2 is a perspective view of a beam-recombining system in accordance with the first embodiment of the present invention;

FIG. 3 is a front view of a beam-recombining system in accordance with the first embodiment of the present invention;

FIG. 4 is a top view of a beam-recombining system (after removing the polarizing beam splitter module, the image displaying module and the projection lens module) in accordance with the first embodiment of the present invention;

FIG. 5 is a side view of a beam-recombining system in accordance with the first embodiment of the present invention;

FIG. 6 is a perspective view of a beam-recombining system in accordance with the second embodiment of the present invention;

FIG. 7 is a front view of a beam-recombining system in accordance with the second embodiment of the present invention;

FIG. 8 is a top view of a beam-recombining system (after removing the polarizing beam splitter module, the image displaying module and the projection lens module) in accordance with the second embodiment of the present invention;

FIG. 9 is a side view of a beam-recombining system in accordance with the second embodiment of the present invention; and

FIG. 10 is a flow chart of a beam-recombining method of a modular beam-recombining system in accordance with the second embodiment of the present invention.

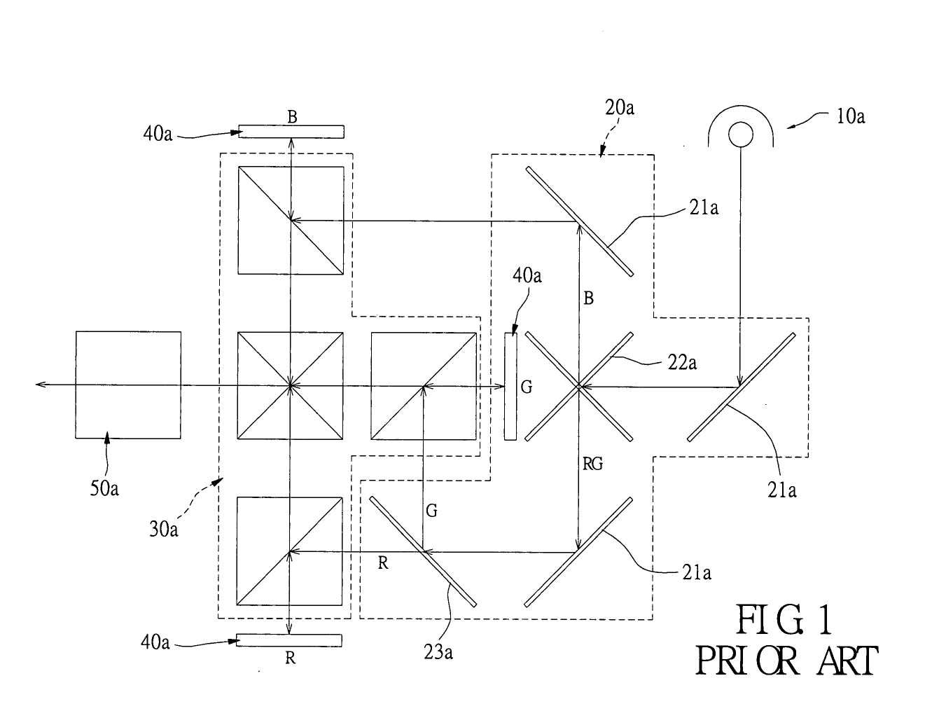

### DETAILED DESCRIPTION OF PREFERRED EMBODIMENTS

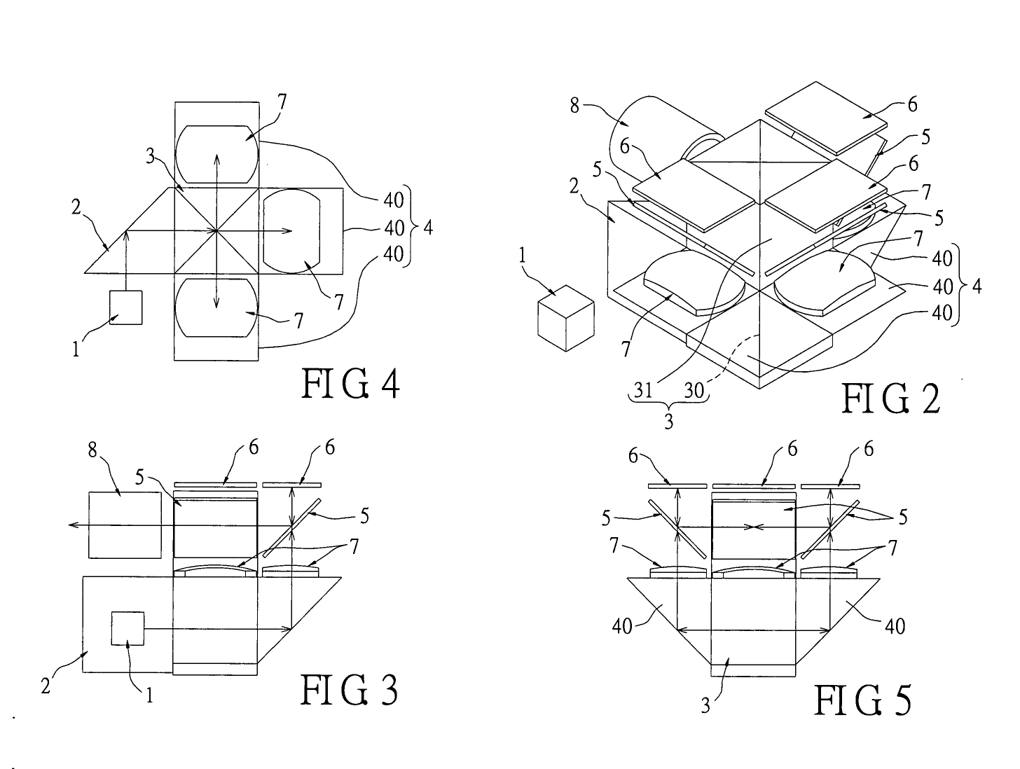

FIGS. 2 to 5 show a perspective, a front, a top (the polarizing beam splitter module, the image displaying module and the projection lens module have been removed) and a side view of a beam-recombining system in accordance with the first embodiment of the present invention, respectively. The first embodiment of the present invention provides a modular beam-recombining system including a reflecting module 2, a beam splitting/recombining module 3, a splitting-beam reflecting module 4, a polarizing beam splitter module 5, and an image displaying module 6.

The reflecting module 3 is used to reflect a beam from a light-emitting module 1. The light-emitting module 1 can be a light-emitting diode or an oval-shaped lamp. The beam splitting/recombining module 3 has one side connected (or integratedly connected) with the reflecting module 2 for splitting and recombining the beam. The beam splitting/recombining module 3 can be an X-cube composed of a beam-splitting element (dichroic mirror) 30 and a beam-recombining element (X-prism) 31.

Moreover, the splitting-beam reflecting module 4 is connected (or integratedly connected) with another side of the beam splitting/recombining module 3 for reflecting the beam from the beam splitting/recombining module 3. The splitting-beam reflecting module 4 has a plurality of reflecting prisms 40 or three reflecting prisms 40 connected with other three sides of the beam splitting/recombining module 3, respectively. In addition, each of the reflecting prisms 40 is an isosceles right triangle prism with an optical grinding surface.

Furthermore, the polarizing beam splitter module 5 is arranged correspondingly above the splitting-beam reflecting module 4 for receiving the beam from the splitting-beam reflecting module 4. The polarizing beam splitter module 5 can be a PBS (Polarizing Beam Splitter) or a plate PBS. In addition, the image displaying module 6 is arranged correspondingly above the polarizing beam splitter module 5 for receiving and reflecting the beam projected from the polarizing beam splitter module 5 to form an image beam. The image displaying module 6 can be an image display element or a light valve.

Moreover, the first embodiment of the present invention further includes a beam-condensing module 7 and a projection lens module 8. The beam-condensing module 7 is arranged between the splitting-beam reflecting module 4 and the polarizing beam splitter module 5, and the beam-condensing module 7 can be plurality of field lenses or condensers. The projection lens module 8 is arranged outside the beam-recombining element 31 of the beam splitting/recombining module 3 in order to converge the image beams that are projected from the polarizing beam splitter module 5, and project the converged image beams onto a panel (not shown).

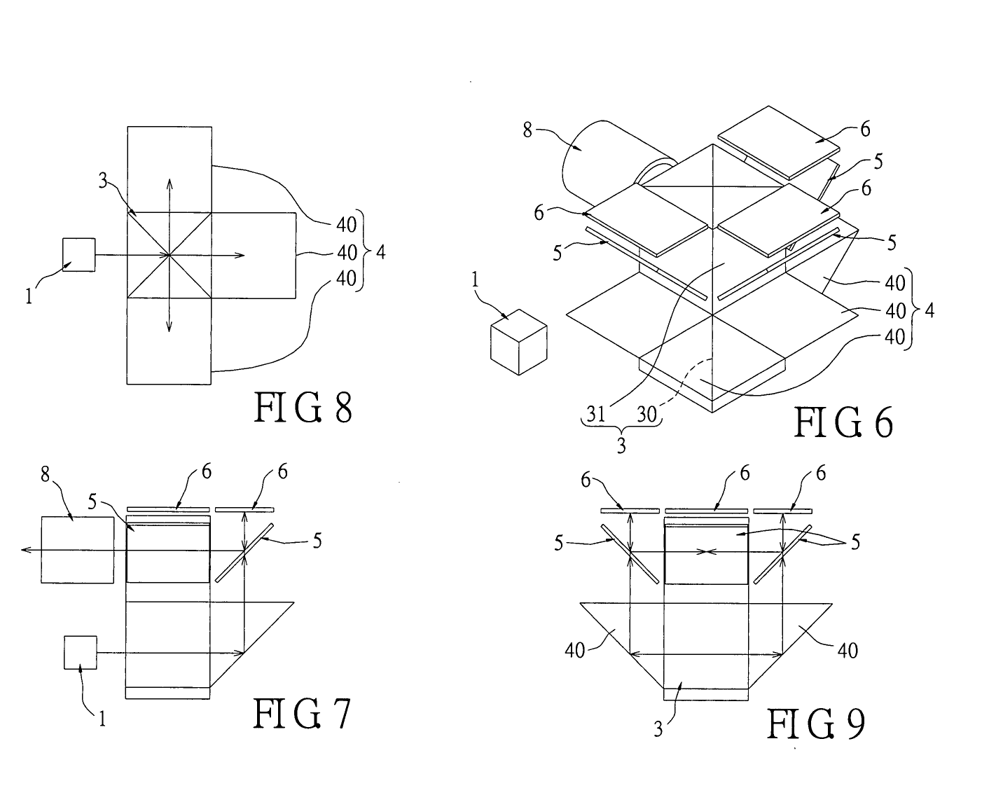

FIGS. 6 to 9 show a perspective, a front, a top (the polarizing beam splitter module, the image displaying module and the projection lens module have been removed) and a side view of a beam-recombining system in accordance with the second embodiment of the present invention, respectively. The difference between the first embodiment and the second embodiment is that the beam-recombining system of the second embodiment lacks the reflecting module 2 and the beam-condensing module 7. In other words, the beam splitting/recombining module 3 can used to receive directly the beam produced from the light-emitting module 1 without using the reflecting module 2 in order to split and recombine the beam.

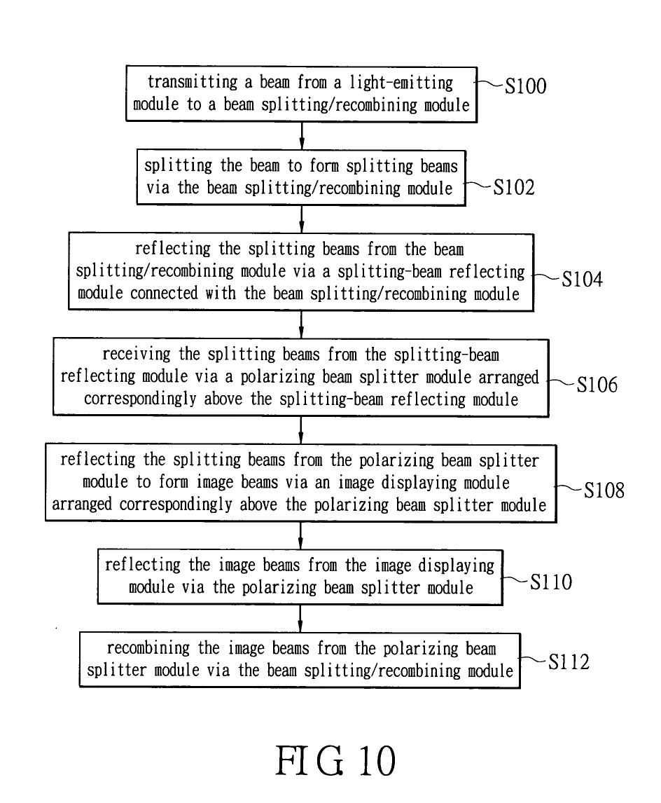

FIG. 10 shows a flow chart of a beam-recombining method of a modular beam-recombining system in accordance with the second embodiment of the present invention. The method of the second embodiment includes the following steps: transmitting a beam from a light-emitting module 1 to a beam splitting/recombining module 2 (S100); splitting the beam to form splitting beams via the beam splitting/recombining module 2 (S102); reflecting the splitting beams from the beam splitting/recombining module 2 via a splitting-beam reflecting module 4 connected with the beam splitting/recombining module 2 (S104); and receiving the splitting beams from the splitting-beam reflecting module 4 via a polarizing beam splitter module 5 arranged correspondingly above the splitting-beam reflecting module 4 (S106).

Furthermore, the method further includes: reflecting the splitting beams from the polarizing beam splitter module 5 to form image beams via an image displaying module 6 arranged correspondingly above the polarizing beam splitter module 5 (S108); reflecting the image beams from the image displaying module 6 via the polarizing beam splitter module 5 (S110); and recombining the image beams from the polarizing beam splitter module 5 via the beam splitting/recombining module 3 (S112).

In conclusion, the present invention use an integrated method to integrate the beam splitting/recombining module 3, the splitting-beam reflecting module 4, the polarizing beam splitter module 5 and the image displaying module 6 together for providing some advantages including having the same RGB optical path, high contrast, a high optical level (because the splitting-beam reflecting module 4 has an optical grind surface), small volume and ease of manufacture.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A modular beam-recombining system comprising:
a reflecting module for reflecting a beam from a light-emitting module;
a beam splitting/recombining module having one side connected with the reflecting module, for splitting and recombining the beam;
a splitting-beam reflecting module connected with other side of the beam splitting/recombining module, for reflecting the beam from the beam splitting/recombining module;
a polarizing beam splitter module arranged correspondingly above the splitting-beam reflecting module, for receiving the beam from the splitting-beam reflecting module; and
an image displaying module arranged correspondingly above the polarizing beam splitter module, for receiving and reflecting the beam projected from the polarizing beam splitter module to form an image beam.

2. The modular beam-recombining system as claimed in claim 1, wherein the light-emitting module is a light-emitting diode or an oval-shaped lamp.

3. The modular beam-recombining system as claimed in claim 1, wherein the beam splitting/recombining module is an X-cube composed of a beam-splitting element and a beam-recombining element.

4. The modular beam-recombining system as claimed in claim 1, wherein the splitting-beam reflecting module has a plurality of reflecting prisms.

5. The modular beam-recombining system as claimed in claim 1, wherein the splitting-beam reflecting module has three reflecting prisms connected with other three sides of the beam splitting/recombining module, respectively.

6. The modular beam-recombining system as claimed in claim 5, wherein each of the reflecting prisms is an isosceles right triangle prism with an optical grinding surface.

7. The modular beam-recombining system as claimed in claim 1, wherein the reflecting module is connected integratedly with the one side of the beam splitting/recombining module.

8. The modular beam-recombining system as claimed in claim 1, wherein the splitting-beam reflecting module is connected integratedly with another side of the beam splitting/recombining module.

9. The modular beam-recombining system as claimed in claim 1, further comprising a beam-condensing module arranged between the splitting-beam reflecting module and the polarizing beam splitter module.

10. A modular beam-recombining system comprising:
a beam splitting/recombining module for directly receiving a beam from a light-emitting module, and splitting and recombining the beam;
a splitting-beam reflecting module connected with the beam splitting/recombining module, for reflecting the beam from the beam splitting/recombining module;
a polarizing beam splitter module arranged correspondingly above the splitting-beam reflecting module, for receiving the beam from the splitting-beam reflecting module; and
an image displaying module arranged correspondingly above the polarizing beam splitter module, for receiving and reflecting the beam from the polarizing beam splitter module to form an image beam.

11. A beam-recombining method of a modular beam-recombining system comprising:
transmitting a beam from a light-emitting module to a beam splitting/recombining module;
splitting the beam to form splitting beams via the beam splitting/recombining module;
reflecting the splitting beams from the beam splitting/recombining module via a splitting-beam reflecting module connected with the beam splitting/recombining module;
receiving the splitting beams from the splitting-beam reflecting module via a polarizing beam splitter module arranged correspondingly above the splitting-beam reflecting module;
reflecting the splitting beams from the polarizing beam splitter module to form image beams via an image displaying module arranged correspondingly above the polarizing beam splitter module;
reflecting the image beams from the image displaying module via the polarizing beam splitter module; and
recombining the image beams from the polarizing beam splitter module via the beam splitting/recombining module.
